(19) United States
(12) Patent Application Publication
(10) Pub. No.: US 2026/0212315 A1
(43) Pub. Date: Jul. 23, 2026

(54) System and Method for Intelligent Warehouse Picking Using Hybrid Network Systems and Shelf Identification Modules

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/032,803

(22) Filed: Jan. 21, 2025

(51) Int. Cl. G06Q 10/087; G06Q 10/0631

(52) U.S. Cl. CPC G06Q 10/087; G06Q 10/06312

(57) ABSTRACT

This invention describes a warehouse picking system that integrates hybrid communication networks, including Bluetooth shelf modules, and optional artificial intelligence (AI) components. The system accommodates both AI-enhanced and traditional workflows, facilitating dynamic task management and optimizing inventory processes. Its modular design ensures scalability, efficiency, and reliability in warehouse operations, thereby improving overall productivity and reducing operational costs.

### CROSS-REFERENCE TO RELATED APPLICATIONS

### US Patent Documents

U.S. Pat. No. 10,259,649 B2 April 2019 Raizer et al.
US20230211952 A1 July 2023 Liu et al.

### Other Publication

WO2019140612 A1 July 2019 Dong et al.

### BACKGROUND OF THE INVENTION

Efficient warehouse operations require systems that optimize workflows, reduce human errors, and improve productivity. Existing solutions for warehouse picking primarily rely on either predefined task allocation or partial automation through robotic systems. These systems, however, lack an integrated approach that combines hybrid communication networks, low-power shelf identification modules, and the flexibility to operate with or without AI-based optimizations.

This invention introduces a warehouse picking system designed to overcome these challenges. The system utilizes hybrid communication protocols (Wi-Fi, Bluetooth, and optional powerline communication), Bluetooth-enabled shelf identification modules, and an Inventory Management System (IMS) for dynamic task management. The invention is modular, allowing for an AI-enhanced version for adaptive task optimization and a non-AI version for deterministic workflows.

### SUMMARY OF THE INVENTION

This invention describes a warehouse picking system that integrates hybrid communication networks, including Wi-Fi for task synchronization, Bluetooth for short-range shelf communication, and optional powerline communication for areas with weak signals. It features shelf identification modules equipped with Bluetooth-enabled technology, LED indicators, and numeric displays for precise shelf localization and task confirmation. Mobile devices are utilized for task management, route guidance, and signaling to shelf modules. The system integrates with an Inventory Management System (IMS) to facilitate real-time task generation, tracking, and inventory updates. Additionally, optional AI modules are incorporated for real-time task optimization, dynamic routing, and predictive analytics.

### BRIEF DESCRIPTION OF DRAWINGS

FIG. 1: System Architecture: illustrates a block diagram of the warehouse picking system's architecture, depicting the interconnections between the Inventory Management System (IMS), the hybrid network, mobile devices, and shelf modules.

FIG. 2: Workflow: presents a flowchart outlining the operational workflow of the system, including task generation, routing, shelf identification, and task confirmation processes.

FIG. 3: Shelf Module Design: shows a schematic representation of the shelf module's internal structure, highlighting components such as the Bluetooth receiver, visual indicators, and power management circuitry.

### DETAILED DESCRIPTION OF THE INVENTION

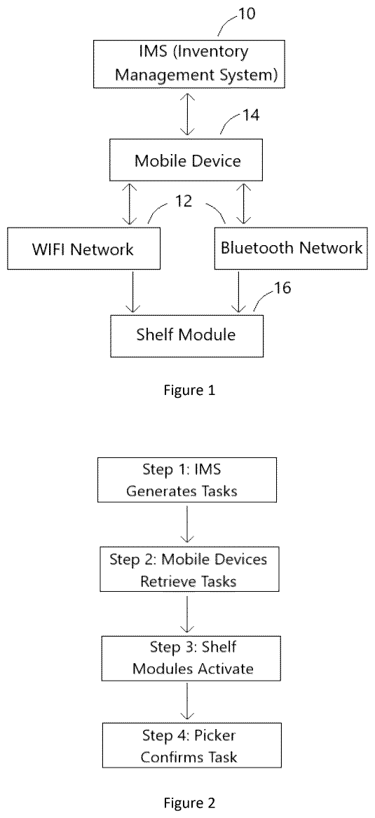

The present invention relates to a warehouse picking system designed to enhance efficiency and accuracy through its unique structural and functional features. As depicted in FIG. 1, the system architecture comprises an Inventory Management System (IMS) (10), a hybrid network (12), a set of mobile devices (14), and a series of shelf modules (16). The IMS (10) maintains up-to-date inventory records and manages order details, while the hybrid network (12) facilitates communication among the IMS (10), the mobile devices (14), and the shelf modules (16). The mobile devices (14) receive picking tasks and relevant navigation information from the IMS (10) over the hybrid network (12). The shelf modules (16) are each equipped with visual indicators (18) that guide warehouse operators to the correct items.

FIG. 2 presents a flowchart outlining the operational workflow of the system, beginning with the generation of picking tasks in the IMS (10), followed by the transmission of those tasks to the mobile devices (14). The mobile devices (14) direct operators to specific shelf modules (16) via routing instructions, and the visual indicators (18) illuminate to highlight the correct items for retrieval. Once an item is picked, the operator confirms completion through the mobile device (14), which updates the IMS (10) to ensure accurate, real-time inventory and order status.

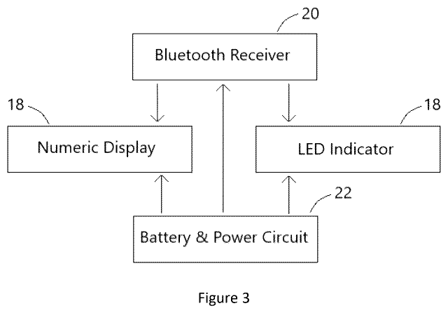

FIG. 3 shows a schematic representation of the shelf module (16), illustrating its internal structure, including a Bluetooth receiver (20), the visual indicators (18), and power management circuitry (22). The Bluetooth receiver (20) enables low-latency communication with the IMS (10) and mobile devices (14), while the power management circuitry (22) optimizes energy usage for prolonged operation. The visual indicators (18) are strategically placed to draw attention to the correct shelf positions, reducing errors in item selection and streamlining the overall picking process. The combination of the IMS (10), hybrid network (12), mobile devices (14), and intelligently designed shelf modules (16) results in a highly coordinated system that improves warehouse productivity, minimizes picking errors, and ensures real-time inventory accuracy.

1. A warehouse picking system comprising:
an Inventory Management System (IMS) configured to generate tasks and track inventory;
a hybrid network system including Wi-Fi for task synchronization, Bluetooth for short-range communication with shelf modules, and optional powerline communication for extended connectivity;
mobile devices configured to synchronize tasks with the IMS, broadcast Bluetooth signals to activate shelf modules, and display task instructions to pickers; and
shelf modules comprising a Bluetooth receiver for signal detection, visual indicators for shelf localization, and a numeric display for task confirmation.

2. The warehouse picking system of claim 1, wherein the hybrid network system includes adaptive switching between Wi-Fi, Bluetooth, and powerline communication.

3. The warehouse picking system of claim 1, wherein the shelf modules are powered by batteries with a lifespan of at least one year.

4. The warehouse picking system of claim 1, further comprising AI modules configured to dynamically calculate optimized picking routes, verify picked items using image recognition, and predict inventory restocking needs.

5. The system of claim 4, wherein AI modules adjust tasks based on real-time warehouse conditions.
